(19) United States
(12) Patent Application Publication
(10) Pub. No.: US 2026/0012212 A1
(43) Pub. Date: Jan. 8, 2026

(54) ENERGY EFFICIENT TRANSMISSION OF RF SIGNALS

(71) Applicant: NOKIA TECHNOLOGIES OY, Espoo (FI)

(72) Inventors: Kim NIELSEN, Storvorde (DK); Christian ROM, Aalborg (DK); Benny VEJLGAARD, Gistrup (DK); Feridoon JALILI, Gistrup (DK)

(21) Appl. No.: 19/257,099

(22) Filed: Jul. 1, 2025

(30) Foreign Application Priority Data
Jul. 2, 2024 (GB) 2409541.6

(51) Int. Cl. H04B 1/04; H04B 17/309; H04W 52/08

(52) U.S. Cl. CPC H04B 1/0483; H04B 17/347; H04W 52/08; H04B 2001/0408

(57) ABSTRACT

The present subject matter relates to an apparatus for transmission of a set of radio frequency (RF) signals using a transmitter. The transmitter comprises a set of power amplifiers for amplification of RF signals and a set of antennas for transmitting the amplified RF signals. The apparatus comprises at least one processor; and at least one memory storing instructions that, when executed by the at least one processor, cause the apparatus to perform: determining a transmission configuration for an energy efficient transmission of the set of RF signals, the transmission configuration indicating a set of transmission paths for transmission of the set of RF signals respectively, each transmission path comprising a respective power amplifier of the set of power amplifiers and a respective antenna of the set of antenna.

### RELATED APPLICATIONS

This application claims priority to United Kingdom patent application No. GB 2409541.6, filed Jul. 2, 2024, entitled “ENERGY EFFICIENT TRANSMISSION OF RF SIGNALS” which is hereby incorporated by reference in its entirety.

### TECHNICAL FIELD

Various example embodiments relate to telecommunication systems, and more particularly to apparatus for transmission of a set of radio frequency (RF) signals using a transmitter.

### BACKGROUND

The sixth-generation wireless networks (6G) refer to a new generation of radio systems and network architecture. 6G represents the next frontier in wireless communication, aiming to revolutionize connectivity with unprecedented data rates, ultra-low latency, and advanced use cases. However, there are significant challenges to overcome.

### SUMMARY

Example embodiments provide an apparatus for transmission of a set of radio frequency (RF) signals using a transmitter, the transmitter comprising a set of power amplifiers for amplification of RF signals and a set of antennas for transmitting the amplified RF signals, the apparatus comprising at least one processor; and at least one memory storing instructions that, when executed by the at least one processor, cause the apparatus to perform: determining a transmission configuration for an energy efficient transmission of the set of RF signals, the transmission configuration indicating a set of transmission paths for transmission of the set of RF signals respectively, each transmission path comprising a respective power amplifier (PA) of the set of power amplifiers and a respective antenna of the set of antennas.

Example embodiments provide a method for transmission of a set of radio frequency (RF) signals using a transmitter, the transmitter comprising a set of power amplifiers for amplification of RF signals and a set of antennas for transmitting the amplified RF signals, the method comprising: determining a transmission configuration for an energy efficient transmission of the set of RF signals, the transmission configuration indicating a set of transmission paths for transmission of the set of RF signals respectively, each transmission path comprising a respective power amplifier of the set of power amplifiers and a respective antenna of the set of antennas.

Example embodiments provide a computer program product comprising processor executable instructions for causing an apparatus for performing at least the method.

Example embodiments provide a non-transitory computer readable medium comprising program instructions that, when executed by an apparatus, cause the apparatus to perform at least the method.

### BRIEF DESCRIPTION OF THE DRAWINGS

The accompanying figures are included to provide a further understanding of examples, and are incorporated in and constitute part of this specification. In the figures:

FIG. 1A is a schematic illustration of a wireless communication system in accordance with an example of the present subject matter;

FIG. 1B is a diagram of a transmitter in accordance with an example of the present subject matter;

FIG. 2 is a flowchart of a method for energy efficient transmission of RF signals according to an example of the present subject matter;

FIG. 3A is a diagram of a transmitter illustrating a method for determining the available power capacity of the power amplifiers of the transmitter in accordance with an example of the present subject matter;

FIG. 3B is a diagram of a transmitter illustrating a transmission configuration in accordance with an example of the present subject matter;

FIG. 3C is a diagram of a transmitter illustrating a transmission configuration in accordance with an example of the present subject matter;

FIG. 4 is a flowchart of a method used in a user equipment according to an example of the present subject matter;

FIG. 5 is a flowchart of a method used in a user equipment according to an example of the present subject matter;

FIG. 6 is a diagram of a transmitter for enabling energy efficient transmission of data in accordance with an example of the present subject matter;

FIG. 7 is a diagram of a transmitter for enabling energy efficient transmission of data in accordance with an example of the present subject matter;

FIG. 8 is a block diagram showing an example of an apparatus according to an example of the present subject matter.

### DETAILED DESCRIPTION

In the following description, for purposes of explanation and not limitation, specific details are set forth such as particular architectures, interfaces, techniques, etc., in order to provide a thorough understanding of the examples. However, it will be apparent to those skilled in the art that the disclosed subject matter may be practiced in other illustrative examples that depart from these specific details. In some instances, detailed descriptions of well-known devices and/or methods are omitted so as not to obscure the description with unnecessary detail.

The present subject matter may enable independent control of the transmitter's output power per antenna, with little to no assistance from the wireless communication system. It can dynamically adapt transmission paths based on the transmission conditions and the status of the power amplifiers. This may improve spectral and energy efficiency, increase network capacity, adapt to environmental changes, and better handle diverse traffic types. This flexibility and adaptability may be crucial for maintaining optimal performance in complex and ever-changing wireless communication environments, particularly in the 6G landscape.

The wireless communication system comprises nodes such as base stations, wherein each node may serve user equipments (UEs) located within the node's geographical area of service. The wireless communication system may support one or more radio access technologies (RATs). A radio access technology of the radio access technologies may, for example, be evolved universal terrestrial radio access (E-UTRA), 5G new radio (NR), or a 6G based system, but it is not limited to, as a person skilled in the art may apply the present subject matter to other wireless communication systems provided with necessary properties.

Each power amplifier in the set of power amplifiers may have a specified power capability, which is the maximum power it can provide at its output. The actual power delivered by the power amplifier, referred to as the power amplifier output level, may be less than or equal to its power capability. The difference between the power amplifier output level and its power capability is referred to as the individual remaining available power capacity or individual available power capacity.

The transmission configuration may enable the energy efficient transmission of the set of RF signals. The energy efficient transmission of the set of RF signals may comprise a transmission of the set of RF signals. The energy efficient transmission may optimize the energy consumption of transmitting the set of RF signals while maintaining acceptable levels of performance, such as data rate, reliability, and coverage. In one example, the energy efficient transmission of the set of RF signals may comprise the transmission of the set of RF signals such that the energy required to transmit the set of RF signals is smaller than a reference maximum energy. The reference maximum energy may be a predefined value, determined based on the highest possible energy consumption of the entire set of power amplifiers.

The transmission configuration may provide a mapping between the set of RF signals, the set of power amplifiers and the set of antennas that may enable the energy efficient transmission of the set of RF signals (e.g., the mapping may be referred to as uplink-to-antenna mapping).

In one example, the determining of the transmission configuration for the energy efficient transmission of the set of RF signals may be performed using the power capabilities of the set of power amplifiers and pathlosses associated with the set of antennas. The pathloss of an antenna (i.e., associated with the antenna) may refer to a reduction in power of a signal propagating between the antenna via which the signal is transmitted and a receiver of the signal.

In one example, the power (referred to as data power) required to transmit each RF signal of the set of RF signals may be determined. The data powers, the power capabilities of the set of power amplifiers and the pathlosses associated with the set of antennas may be used to determine of the transmission configuration for the energy efficient transmission of the set of RF signals.

In one example, the apparatus may be served by a node of a network of the wireless communication system. The node may send, based on a specific input from the apparatus, feedback to the apparatus for defining the power amplifier output level for each power amplifier of the set of power amplifiers. The apparatus may or may not use the feedback to define the power amplifier output level for each power amplifier of the set of power amplifiers depending on a power control mode being used. The specific input may, for example, be signals received from the apparatus and/or a power headroom report.

Before the transmission of the set of RF signals, the set of power amplifiers of the apparatus may have an available remaining power capacity.

In one example, the power capabilities of the set of power amplifiers may comprise at least two distinct power capabilities. In one example, the power capabilities of the set of power amplifiers may comprise one more distinct power capabilities.

The set of RF signals may have frequencies that belong to one frequency band or belong to multiple frequency bands. Across one frequency band, channel conditions may be more consistent, simplifying the implementation of transmission techniques such as Multiple Input Multiple Output (MIMO) technique. Utilizing multiple frequency bands may increase the total available spectrum, enhancing overall network capacity and throughput and enabling implementation of transmission techniques such as carrier aggregation (CA) technique.

According to one example, the transmitter is controlled for transmitting the set of RF signals in accordance with the transmission configuration. For example, each RF signal of the set of RF signal may be amplified by the power amplifier of the respective transmission path and the resulting amplified RF signal may be transmitted through the antenna of the transmission path. Each power amplifier of the set of power amplifiers may be set to the power amplifier output level that enables to amplify the respective RF signal.

According to one example, the determining of the transmission configuration is performed for satisfying a criterion on a remaining available power capacity of the set of power amplifiers upon using the transmission configuration for the transmission of the set of RF signals. The remaining available power capacity of the set of power amplifiers may be estimated based on the assumption that the set of RF signals has been transmitted according to the transmission configuration, without actually transmitting them. The satisfaction of the criterion may enable the energy efficient transmission of the set of RF signals. The remaining available power capacity of the set of power amplifiers may be the overall remaining available power capacity of the set of power amplifiers. The remaining available power capacity of the set of power amplifiers may, for example, be the sum of the individual remaining available power capacities of the set of power amplifiers respectively. Alternatively, the remaining available power capacity of the set of power amplifiers may, for example, be the weighted sum of the individual remaining available power capacities of the set of power amplifiers respectively, wherein each power amplifier may be assigned a respective weight.

According to one example, the criterion requires a maximization of the remaining available power capacity. That is, the set of transmission paths are determined such that the remaining available power capacity is maximized. This example may allow for increased energy savings compared to using a fixed or random set of transmission paths. Alternatively, the criterion may require a second order maximization of the remaining available power capacity. This may enable to find the second maximum remaining available power capacity in the set of power amplifiers. With this example, the node serving the apparatus may, for example, see only a power headroom report indicating the apparatus having plenty of available power capacity, since the apparatus has optimized its transmission paths for this purpose.

According to one example, the determining of the transmission configuration may comprise: determining different candidate sets of transmission paths for transmission of the set of RF signals. For each of the candidate sets of transmission paths the available power capacity of the set of power amplifiers may be determined. The criterion may require selecting a candidate set of transmission paths having the available power capacity higher than a lowest available power capacity in the candidate sets of transmission paths. The set of transmission paths of the transmission configuration is the selected candidate set of transmission paths. In one example, the selected candidate set of transmission paths may have the highest available power capacity.

For example, each candidate set of transmission paths of the candidate sets of transmission paths may be associated with an available power capability of the entire set of power amplifiers. These available power capabilities may be ranked, and any candidate set of transmission paths that is associated with the available power capability above the lowest ranked available power capability may be selected (e.g., randomly) in the above example.

For example, the number of the different candidate sets of transmission paths may be the total number of all possible distinct sets of transmission paths. If the number of the set of power amplifiers is n and the number of set of antennas is n, then the number of the different candidate sets of transmission paths may, for example, be provided based on a number (e.g., total number) of pairs of elements of the two sets. For example, if the set of power amplifiers comprises two power amplifiers and the set of antennas comprises two antennas, the candidate sets of transmission paths may be two candidate sets of transmission paths. This example, which defines the transmission paths using only the set of power amplifiers and the set of antennas, may be advantageous when the set of RF signals are identical or require the same power levels. Alternatively, if the number of the set of power amplifiers is n, the number of set of antennas is n, and the number of the set of RF signals is n then the number of the different candidate sets of transmission paths may, for example, be provided be provided based on a number (e.g., total number) of triplets of elements of the three sets.

According to one example, the determining of the transmission configuration may comprise: sorting the set of power amplifiers by their power capabilities in accordance with a first sorting order. The first sorting order is ascending or descending. The sorting may result in a ranking of the set of power amplifiers. The set of antennas may be sorted by their pathlosses in accordance with a second sorting order. The second sorting order is reversed with respect to the first sorting order. The pathloss of an antenna indicates a reduction in power of a signal propagating between the antenna and a receiver. The sorting may result in a ranking of the set of antennas. Each transmission path may be defined in accordance with the rankings so that the transmission path comprises the power amplifier and the antenna of the same ranking of the set of power amplifiers and the set of antennas.

This example may enable a systematic method for selecting transmission paths in a time-efficient manner. This may particularly be advantageous given the stringent delay requirements at the physical layer for RF signal transmission in 6G.

According to one example (referred to as first power control example), the transmitter comprises a power control system. For each transmission path, the power control system is configured to set a power amplifier output level for the corresponding power amplifier comprised in the transmission path in accordance with a pathloss associated with the corresponding antenna. The determining of the transmission configuration may comprise selecting a transmission path of the set transmission paths whose antenna is associated with a specific pathloss. The power control system may be reconfigured to set the power amplifier output level of each power amplifier in accordance with the specific pathloss. In one example, the power control system may be reconfigured, using a central controller of the apparatus, to set the power amplifier output level of each power amplifier in accordance with the specific pathloss.

The power control system may initially be configured to determine and set the power amplifier output level required to transmit each RF signal using an existing technique. This example can be seamlessly integrated with existing systems, as it allows the reconfiguration of the power control system to use the power amplifier output levels defined by the transmission paths specified in the present subject matter.

In one example, the power control system may comprise a power control unit per power amplifier of the set of power amplifiers. Each power control unit may be configured to set the respective power amplifier to the power amplifier output level required to transmit the RF signal through the transmission path comprising the power amplifier.

According to one example (referred to as second power control example), the power control system may be reconfigured, using an individual controller of the apparatus per transmission path, to set the power amplifier output level of each power amplifier in accordance with the specific pathloss and a respective delta layer adjustment, wherein the delta layer adjustment represents a difference between the pathloss of the selected transmission path and the pathloss of the transmission path associated with the each power amplifier.

The second power control example may enable power control per transmission path. The delta power control may be managed by the apparatus internally. With the second power control example, the signals from the set of antennas may be received at the node with the same input power level. For example, by using the delta layer adjustments, the apparatus may take actions to bring the received power level of the transmission of each antenna to a level, that when received by the network (e.g., at the node) is of equal received signal strength at the network. With these actions, the power amplifier output level used for each transmission path may consider the pathloss of the respective antenna instead of a single pathloss (e.g., the selected pathloss).

According to one example, the specific pathloss may be the smallest pathloss of the set of transmission paths. Using the antenna with the lowest pathloss may enable a stronger signal reaching the receiver. This stronger signal may help to fine-tune power levels and improve communication quality.

According to one example, the setting of the power amplifier output levels is performed in accordance with a single closed loop power control associated with the selected transmission path. The single closed loop power control may be used for the first power control example as well as for the second power control example.

For example, the power amplifier output level that is set to each power amplifier X may be defined as follows: P=P_{data}+P_{pathLoss}+P_{feedback}, where the first term P_{data} is the data power for the RF signal to be amplified by the power amplifier X. The second term represents the pathloss. This pathloss may be the pathloss of the antenna associated with the power amplifier X or a pathloss associated with another antenna which is not necessarily associated with the power amplifier X. The third term represents an adjustment as dictated by the wireless communication system. The closed loop power control may, for example, be defined by one antenna of the apparatus and a network node of the wireless communication system, the network node serving the apparatus. The third term may be defined based on feedback provided by the network node of the closed loop power control, wherein the feedback is based on the specific input. The specific input may include, for example, signal(s) transmitted through the antenna involved in the closed loop power control. Alternatively, the power amplifier output level that is set to each power amplifier may be defined using the first two terms only, as follows: P=P_{data}+P_{pathLoss}. This may be implemented in case of an open loop power control. In one example, the power amplifier output level P for a given transmission path that is different from the selected transmission path (having the specific pathloss) may be adapted using the delta adjustment layer associated with the given transmission path. This may enable to bring the received power level of the transmission of each antenna to a level, that when received by the network node is of equal received signal strength at the network node.

According to one example implementation of the first power control example, the transmitter is controlled for transmitting the set of RF signals in accordance with the transmission configuration. The set of RF signals may, for example, be simultaneously transmitted. In addition, the least individual remaining available power capacity of a power amplifier of the set of power amplifiers may be reported in accordance with the closed loop power control. The specific input may additionally or alternatively comprise the reported least individual remaining available power capacity. This reported least individual remaining available power capacity may trigger the node to assign highest rank and/or best Modulation and Coding Scheme (MCS). The apparatus thereby may optimize the throughput. The rank may refer to the number of independent data streams that can be simultaneously transmitted by the transmitter.

According to one example implementation of the second power control example, the transmitter is controlled for transmitting the set of RF signals in accordance with the transmission configuration. The set of RF signals may, for example, be simultaneously transmitted. In addition, the least individual remaining available power capacity of a power amplifier (PA1) of the set of power amplifiers may be reported in accordance with the closed loop power control until the individual remaining available power capacity of the power amplifier PA1 reaches a minimum power capacity, and thereafter the second least individual remaining available power capacity of another power amplifier (PA2) of the set of power amplifiers may be reported in accordance with the closed loop power control.

Reporting the least individual remaining available power capacity may allow the highest rank until the power amplifier PA1 reaches the minimum power capacity. As power is forced up, the individual remaining available power capacity of the power amplifier PA1 diminishes, which the node sees as the apparatus reaching its transmitted maximum, but actually the apparatus reports the least individual remaining available power capacity to convince the node that the balance of all power levels to be used for maximum MCS assignments. Immediately before the minimum power capacity is reached, the apparatus may switch to report the second least individual remaining available power capacity. This may suddenly make the node see that the apparatus has even more power before reaching maximum, but as the node pushes up the output power requests then the uplink at the antenna associated with the power amplifier PA1 may start to drop in power (creating power imbalance). Only when the layer imbalance starts to be seen at the node it may react to the potential rank decrease e.g., in UL-MIMO, which may also include reconsidering the MCS.

According to one example, upon transmitting the set of RF signals and performing the reporting as described in the first or second power control example, the apparatus may receive feedback from the node. In response, the apparatus may repeat the present method for determining a transmission configuration for energy efficient transmission of another set of RF signals, wherein the number of the other set of RF signals may be the same or different from the number of the set of RF signals depending on whether the feedback indicates a specific rank.

According to one example (referred to as front-end module example), the set of antennas comprises multiple subsets of antennas and the set of amplifiers comprises multiple subsets of power amplifiers. Each subset of power amplifiers is associated with a corresponding subset of antennas of the multiple subsets of antennas. Each subset of antennas of the multiple subsets of antennas is comprised in a different front-end module (FE-module). The transmission configuration is determined such that each transmission path of the set of transmission paths comprises the power amplifier and the antenna of the corresponding subset of power amplifiers and subset of antennas.

For example, the multiple subsets of power amplifiers may be psub1 . . . psubN and the multiple subsets of antennas may be asub1 . . . asubN. The multiple subsets of antennas asub1 . . . asubN may be comprised in FE-module1 . . . FE-moduleN respectively. Each j-th subset of antennas asubj is associated with the j-th subset psubj of power amplifiers. Each i-th transmission path may comprise a power amplifier of the j-th subset psubj and an antenna of the corresponding j-th subset asubj.

According to one example, the transmitter is configured to transmit RF signals in accordance with Frequency division duplexing (FDD), wherein the apparatus is further caused to determine pathlosses associated with the set of antennas using network information. For example, when the wireless communication system is not a time division duplex (TDD) system, but an FDD system, the apparatus may replace the process of determining the relation between the received signal level and the pathloss, to be an indication of measured metric the network shares. This shared metric may be used by the apparatus to determine a received layer power e.g., at a NodeB side of the wireless communication system, which the apparatus can use for balancing the uplink (UL).

According to one example, the apparatus is a user equipment or comprised in a user equipment. The apparatus may be configured to connect to the transmitter. In one example, the transmitter comprises the apparatus.

According to one example, the set of RF signals are defined in accordance with a Multiple Input Multiple Output (MIMO) technique. Advantages of this example may include an optimized PA implementation design for UL-MIMO enabled by Uplink Carrier Aggregations (ULCAs), and UE implementation that may require no NodeB assistance for optimized uplink routing and UL-MIMO layer power balancing, which are both new and novel. Additionally, it may ensure balanced output power for uplink transmission, improved UL-MIMO power per layer, and overall uplink throughput improvement.

According to one example, the determining of the transmission configuration may be performed for satisfying another criterion on individual remaining available power capacities of the set of power amplifiers upon using the transmission configuration for the transmission of the set of RF signals. For example, if a power amplifier of different power capability also has differences in gain, it could be possible to go straight for the balancing of power levels, rather than creating a most available power capacity. This may also enable energy efficient transmission of the set of RF signals.

Hence, the present subject matter may leverage architectures with multiple PA power class levels, optimizing routing to enhance uplink performance while minimizing power consumption. The apparatus may benefit from having smaller PAS by design than the power class it is intended for, which may be advantageous for products focused on cost, size, heating, and power consumption.
Example 1: an apparatus comprising at least one processor; and at least one memory storing instructions that, when executed by the at least one processor, cause the apparatus to perform: determining a transmission configuration for a transmission of a set of radio frequency (RF) signals using a transmitter, the transmitter comprising a set of power amplifiers for amplification of RF signals and a set of antennas for transmitting the amplified RF signals, the transmission configuration indicating a set of transmission paths for transmission of the set of RF signals respectively, each transmission path comprising a respective power amplifier of the set of power amplifiers and a respective antenna of the set of antennas.
Example 2: an apparatus comprising means configured for: determining a transmission configuration for a transmission of a set of radio frequency (RF) signals using a transmitter, the transmitter comprising a set of power amplifiers for amplification of RF signals and a set of antennas for transmitting the amplified RF signals, the transmission configuration indicating a set of transmission paths for transmission of the set of RF signals respectively, each transmission path comprising a respective power amplifier of the set of power amplifiers and a respective antenna of the set of antennas.

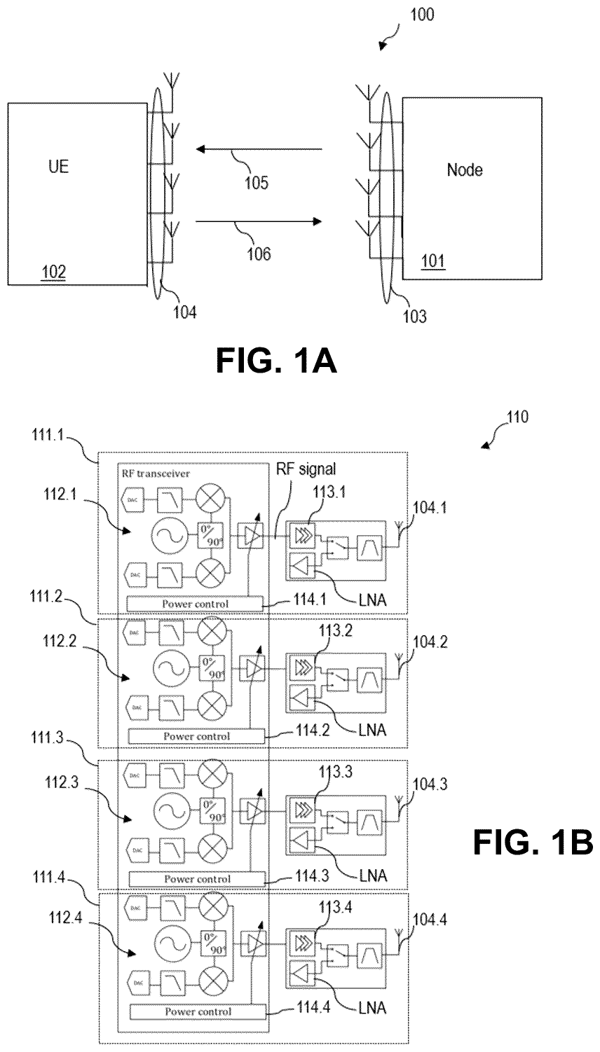

FIG. 1A is a schematic illustration of a wireless communication system 100 in accordance with an example of the present subject matter. The communication system 100 may be configured to use a TDD technique or FDD technique for data transmission.

The wireless communications system 100 includes a node 101 serving a user equipment 102. The node 101 may include a plurality of antennas 103, which may be used for transmission and reception of RF signals. The user equipment 102 may include a plurality of antennas 104 which may be used for transmission and reception of RF signals. Transmissions from the node 101 to the user equipment 102 may be referred to as downlink (DL) transmissions and may occur over one or more DL channels 105. Transmissions from the user equipment 102 to the node 101 may be referred to as uplink (UL) transmissions and may occur over one or more UL channels 106. The UL channels may include a UL data channel such as a Physical UL Shared Channel (PUSCH), a UL control channel such as a Physical UL Control Channel (PUCCH), and a UL sounding signal such as a UL sounding reference symbol (SRS).

As shown in FIG. 1B, the user equipment 102 may comprise a transmitter 110 for transmission of RF signals. The transmitter 110 comprises multiple transmit chains 111.1, 111.2, 111.3 and 111.4 (individually or collectively referred to herein with reference 111). For simplification of the description, only four transmit chains are shown. The transmit chains 111 comprise respectively modulators 112.1 through 112.4 (individually or collectively referred to herein with reference 112), power amplifiers 113.1 through 113.4 (individually or collectively referred to herein with reference 113), power control units 114.1 through 114.4 (individually or collectively referred to herein with reference 114) and antennas 104.1 through 104.4 (individually or collectively referred to herein with reference 104). The antenna may also be referred to as antenna port. The power amplifiers 113 may be of different output power capabilities. The modulators 112 and the power control units 114 may, for example, form an RF transceiver of the transmitter 110.

For example, each of the power amplifiers 113 may meet the requirement to at least provide the output power level according to their output power capability to every antenna, meaning that if, for example, the power amplifier 113.4 would be designed to deliver at least 17 dBm in a 4 UL-MIMO configuration matching the requirements of a power class 3 3GPP compliant device, the power amplifier 113.4 has capacity and calibration that makes 17 dBm available to any of the antennas 104.

In each modulator 112, the I and Q symbol streams are converted to analog by a respective Digital-to-Analog Converter (DAC). A local oscillator generates the carrier sinusoid. The local oscillator signal becomes the I carrier, and a 90° phase shift is applied to create the Q carrier. The I and Q carriers are multiplied by the I and Q data streams, and the two signals resulting from these multiplications are summed to produce a modulated waveform which is the RF signal. Each amplifier 113 may be controlled by the power control unit 114 of the respective transmit chain.

The LNAs of receiver chains which are not shown (for simplification of the drawing) to connect to the RF transceiver, may connect to four down-conversion receivers.

Although the transmit chains are shown to comprise specific combinations of power amplifiers and antennas, the present subject matter may advantageously dynamically define the components that belong to each transmit chain for energy efficient transmissions.

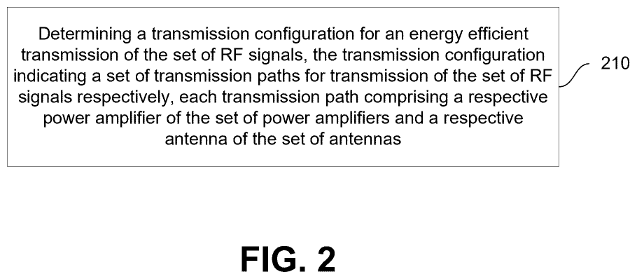

FIG. 2 is a flowchart of a method according to an example of the present subject matter. For the purpose of explanation, the method described in FIG. 2 may be implemented in the system illustrated in FIGS. 1A-B but is not limited to this implementation. The method may, for example, be performed by an apparatus which is part of the user equipment 102.

A transmission configuration may be determined in step 201 for an energy efficient transmission of a set of RF signals. The transmission configuration indicates a set of transmission paths for transmission of the set of RF signals respectively. Each transmission path comprises a respective power amplifier of the set of power amplifiers and a respective antenna of the set of antennas.

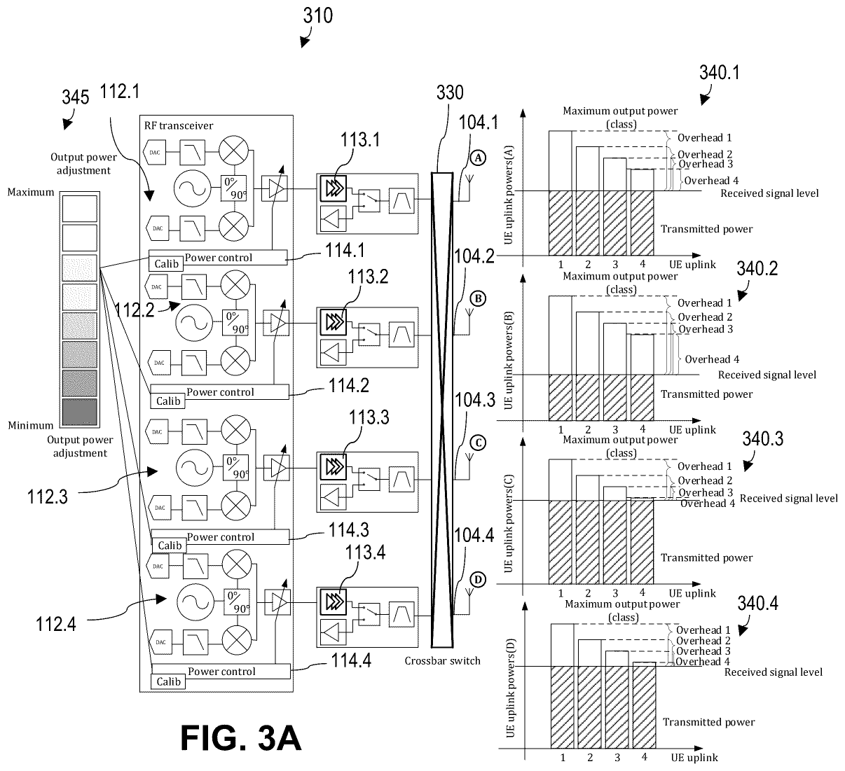

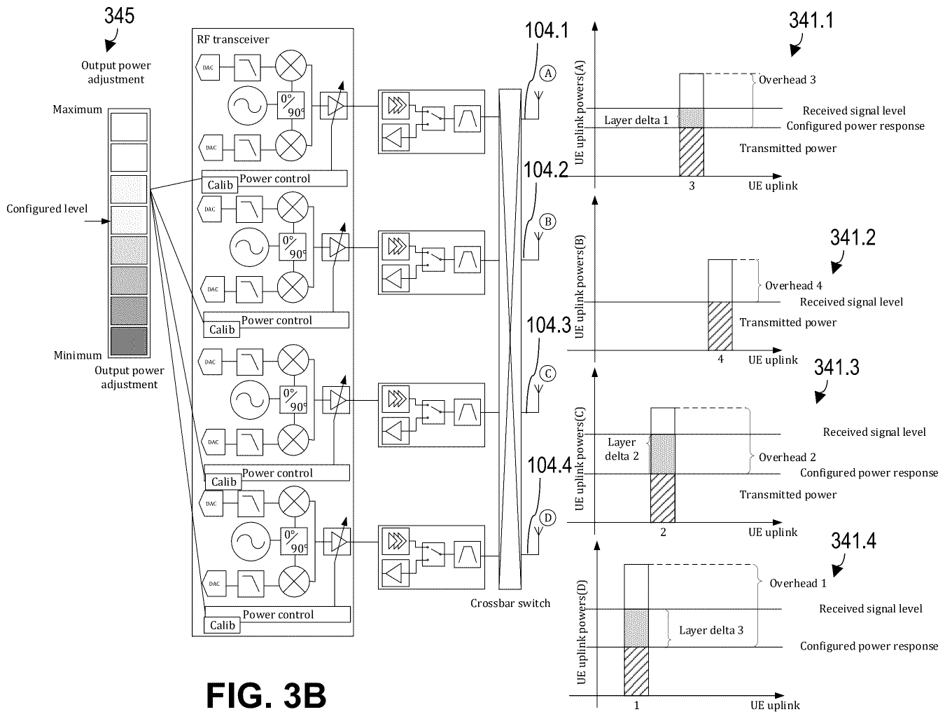

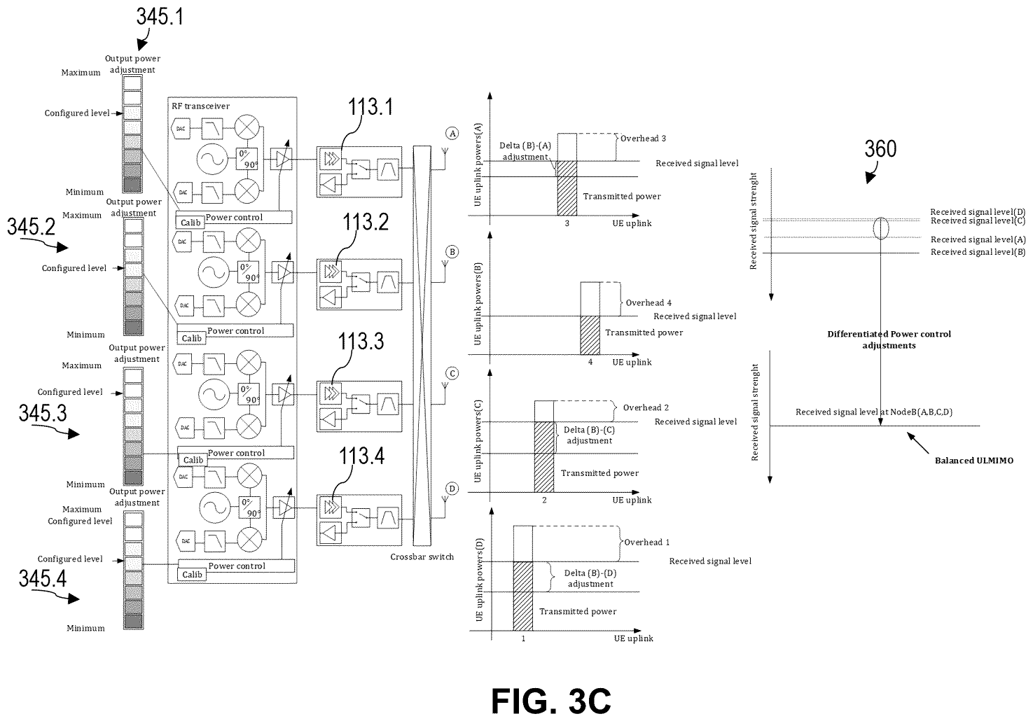

FIG. 3A is a diagram of a transmitter illustrating a method for determining the available power capacity of the power amplifiers of the transmitter in accordance with an example of the present subject matter.

The transmitter 310 shown in FIG. 3A is similar to the transmitter depicted in FIG. 1B, with the addition of a crossbar switch or MUX 330 in the transmitter 310. The crossbar switch 330 may allow every power amplifier 113 to connect to any of the antennas 104.

FIG. 3A shows four histograms 340.1 through 340.4 representing four different test transmission configurations respectively (individually or collectively referred to herein with reference 340). Each test transmission configuration is associated with a specific pathloss. The pathloss may be determined from the received signal level associated with the antenna. The test transmission configuration of the histogram 340.1 may use the pathloss associated with the antenna 104.1 to determine the power amplifier output level to be set for each power amplifier of the power amplifiers 113. The test transmission configuration of the histogram 340.2 may use the pathloss associated with the antenna 104.2 to determine the power amplifier output level to be set for each power amplifier of the power amplifiers 113. The test transmission configuration of the histogram 340.3 may use the pathloss associated with the antenna 104.3 to determine the power amplifier output level to be set for each power amplifier of the power amplifiers 113. The test transmission configuration of the histogram 340.4 may use the pathloss associated with the antenna 104.4 to determine the power amplifier output level to be set for each power amplifier of the power amplifiers 113.

FIG. 3A further illustrates a central controller 345 for controlling the power control units 114.1 through 114.4 in accordance the test transmission configuration. Each column in the histogram 340 represents a perspective power amplifier 113. Each column in the histogram 340 shows the power capability and the output power level that is set to the perspective power amplifier 113. For example, columns numbered 1, 2, 3 and 4 represent the power amplifiers 113.1, 113.2, 113.3 and 113.4 respectively. Each histogram further shows the individual available power capacities of the power amplifiers 113. The individual available power capacity of the power amplifier 113.1 is referred to overhead 1. The individual available power capacity of the power amplifier 113.2 is referred to overhead 2. The individual available power capacity of the power amplifier 113.3 is referred to overhead 3. The individual available power capacity of the power amplifier 113.4 is referred to overhead 4.

Using the histograms 340.1 through 340.4, an optimal transmission configuration may be determined for maximizing the overall overhead. This is shown in FIG. 3B, where the determined transmission configuration includes four new transmission paths and use the pathloss associated with the antenna 104.2. A first transmission path comprises the power amplifier 113.3 and the antenna 104.1. A second transmission path comprises the power amplifier 113.4 and the antenna 104.2. A third transmission path comprises the power amplifier 113.2 and the antenna 104.3. A fourth transmission path comprises the power amplifier 113.1 and the antenna 104.4.

For simplification of the drawings, the new components in the subsequent FIGS. 3B, 3C, 6 and 7 are provided with reference numerals. Components previously identified with reference numerals in prior figures retain their original numerals and are not repeated unless necessary for clarity.

As illustrated in FIG. 3B, the four new histograms (340.1 through 340.4) demonstrate that the transmit power is identical for the four transmission paths. This uniformity is achieved by using the central controller (345) and selecting a specific pathloss, such as the pathloss of antenna 104.2. With one closed loop power control that follows the antenna 104.2, the output power levels may be configured as shown in FIG. 3B. For the second transmission path comprising the antenna 104.2, the UE has configured the output power adjustment to meet the received signal level through the closed loop power control of the uplink towards the node. The UE has an overhead, overhead 4, which it may use to inform the node of how much additional output power the UE can deliver. In this reporting, the UE may not consider the individual power capabilities at the other antennas 104.1, 104.3 and 104.4. For the first transmission path comprising the antenna 104.1, the UE applies the same output power adjustment, which may lower the transmitted power at antenna 104.1, while making an even larger overhead, overhead 3. While the uplink 3 has an abundance of overhead (3), it still transmits towards the node at less transmitted power due to the delta in pathloss as indicated by Layer delta 1 above the transmitted power of UE uplink power. This may cause a first offset (Layer delta 1) in UL-MIMO balancing in output power per layer. For the third transmission path comprising the antenna 104.3, the configured level of the output power adjustment has lowered the transmitted power below the received signal of the same antenna. The delta in balancing is bigger than antenna 104.1 (layer delta 2), while there is still an overhead 2. For the fourth transmission path comprising the antenna 104.4, the configured level of the output power adjustment has lowered the transmitted power same as antennas 104.1 and 104.3. The delta in balancing for this path is layer delta 3.

Hence, using a central controller (345) and a selected pathloss, may lead to differences in power between the power amplifier associated with the antenna of the selected pathloss and the remaining power amplifiers. This difference is referred to as delta layer. For example, a 0 dBm transmission power may compensate for the pathloss associated with the antenna 104.2. However, using that compensation for the antenna 104.1 may result in 5 dB less power, meaning the delta layer (layer delta 1) for the first transmission path may be 5 dB.

Although the transmission configuration in FIG. 3B may provide energy-efficient transmission by maximizing the overhead through the routing of the power amplifiers through the MUX, the layer deltas may affect the MCS configuration at the node for the uplink. To solve this, instead of using a central controller, individual controllers 345.1, 345.2, 345.3 and 345.4 may be used as shown in FIG. 3C, where, for example, each power amplifier may be controlled with the respective configured level in order to compensate for the respective layer delta. As shown in FIG. 3C, the delta layer adjustment for the first transmission path may be referred to as “Delta (B)-(A) adjustment” and represent a difference between the pathloss of the antenna (B) 114.2 of the selected transmission path and the pathloss of the antenna (A) 114.1 of the first transmission path. The delta layer adjustment for the third transmission path may be referred to as “Delta (B)-(C) adjustment” and represent a difference between the pathloss of the antenna (B) 114.2 of the selected transmission path and the pathloss of the antenna (C) 114.3 of the third transmission path. The delta layer adjustment for the fourth transmission path may be referred to as “Delta (B)-(D) adjustment” and represent a difference between the pathloss of the antenna (B) 114.2 of the selected transmission path and the pathloss of the antenna (D) 114.4 of the fourth transmission path. Indeed, this is feasible as the UE may know the precise layer delta for each uplink configuration available to each antenna. Also, the assignment of the amplifiers has secured the most overhead for each transmission path. Following the above example, the power amplifier 113.3 may be increased by 5 dB with the respective individual configure level. As indicated with the diagram 360, with the individual control of the transmission paths, the input powers received from each of the antennas at the node may be the same.

Thus, the present subject matter may improve the energy efficiency transmission and quality of the RF signals using the transmitter 310 as shown in FIG. 3C. Still the UE can improve the performance even further. For that, the UE may report the least overhead through the power headroom reporting. This may increase the range of the UL-MIMO configuration as the actual pathloss between the UE antennas and the node has been compensated by the UE internally.

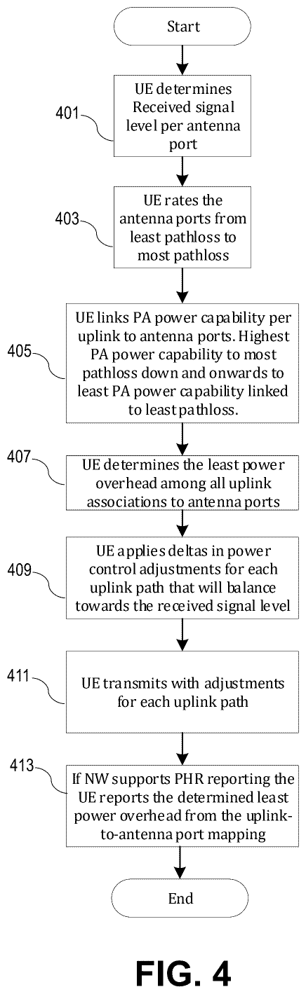

FIG. 4 is a flowchart of a method for transmission of data in accordance with an example of the present subject matter. For the purpose of explanation, the method described in FIG. 4 may be implemented in the system illustrated in FIGS. 1A-B but is not limited to this implementation. The method may, for example, be performed by the user equipment 102.

The UE determines in step 401 a received signal level per antenna port of the transmitter e.g., 110. The UE rates in step 403 the antenna ports from least pathloss to most pathloss. The UE links in step 405 PA power capability per uplink to antenna ports. For example, highest PA power capability to most pathloss down and onwards to least PA power capability linked to least pathloss. The UE applies in step 407 deltas in power control adjustments for each uplink path that may balance towards the received signal level. The UE transmits in step 409 with adjustments for each uplink path. The UE determines in step 411 the least power overhead among all uplink associations to antenna ports. If a network (NW) of the wireless communication supports Power Headroom (PHR) reporting, the UE reports in step 413 the determined least power overhead from an uplink-to-antenna port mapping e.g., as provided by the transmission configuration.

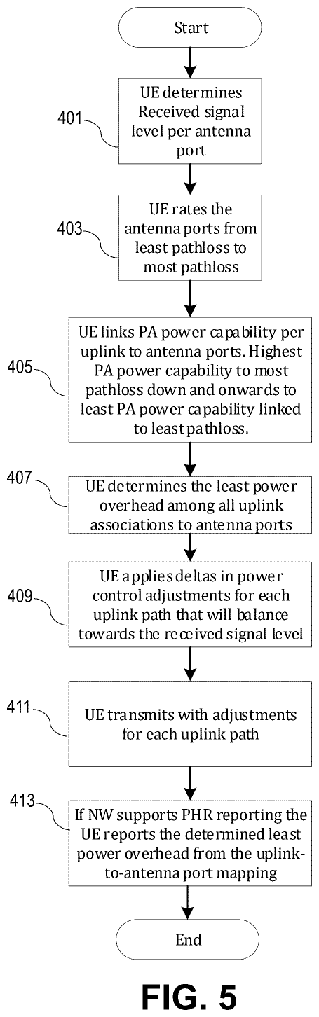

FIG. 5 is a flowchart of a method for transmission of data in accordance with an example of the present subject matter. For the purpose of explanation, the method described in FIG. 5 may be implemented in the system illustrated in FIGS. 1A-B but is not limited to this implementation. The method may, for example, be performed by the user equipment 102.

The UE determines in step 501 a received signal level per antenna port of the transmitter e.g., 110. The UE rates in step 503 the antenna ports from least pathloss to most pathloss. The UE links in step 505 PA power capability per uplink to antenna ports. For example, highest PA power capability to most pathloss down and onwards to least PA power capability linked to least pathloss. The UE applies in step 507 deltas in power control adjustments for each uplink path that may balance towards the received signal level. The UE transmits in step 509 with adjustments for each uplink path. The UE determines in step 511 the least power overhead among all uplink associations to antenna ports. If a network (NW) of the wireless communication supports Power Headroom (PHR) reporting, the UE reports in step 513 the determined least power overhead based on a threshold to maximum uplink power. Once the output power request is above the threshold the UE skips to next least PHR reporting from the uplink-to-antenna port mapping.

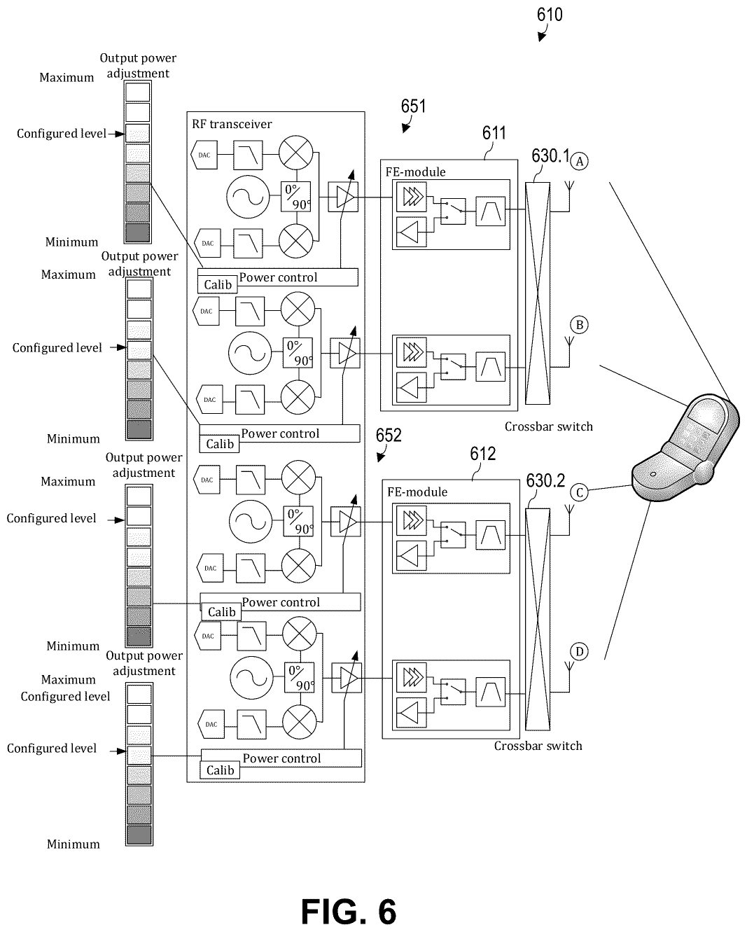

FIG. 6 is a diagram of a transmitter for enabling energy efficient transmission of data in accordance with an example of the present subject matter. FIG. 6 may provide an example implementation of the front-end module example.

The transmitter 610 is similar to the transmitter shown in FIG. 1B, with the antennas being grouped or located in two different FE-modules. For example, the antennas 104.1 and 104.2 are located in the FE-module 611. The antennas 104.3 and 104.4 are located in the FE-module 612. As illustrated in FIG. 6, the two FE modules, 611 and 612, may be located in different parts of a user equipment, such as a smartphone. The FE module 611 may be positioned at the top of the smartphone, while the FE module 612 may be positioned at the bottom of the smartphone. The transmitter 610 comprises two crossbar switches 630.1 and 630.2 associated with the two FE modules 611 and 612 respectively. This may effectively result in two individual transmitters 651 and 652, wherein the transmission of the RF signals in each individual transmitter 651 and 652 may be performed as described with reference to the transmitter in previous figures.

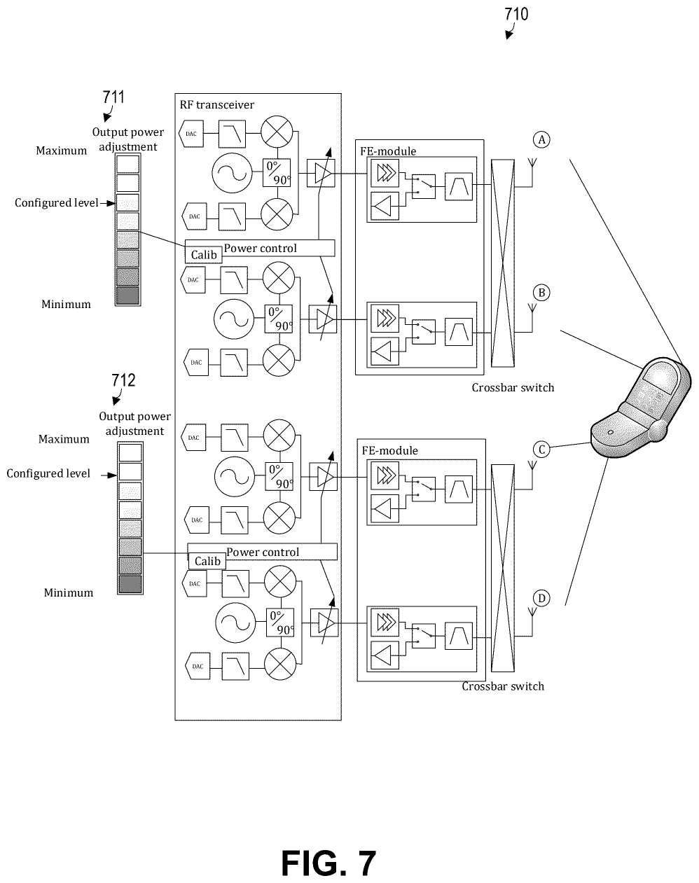

FIG. 7 is a diagram of a transmitter for enabling energy efficient transmission of data in accordance with an example of the present subject matter. The transmitter 710 is similar to the one shown in FIG. 6, but the individual transmitters 651 and 652 are each associated with a central controller 711 or 712 rather than individual controllers. FIG. 7 may provide an example implementation of the front-end module example.

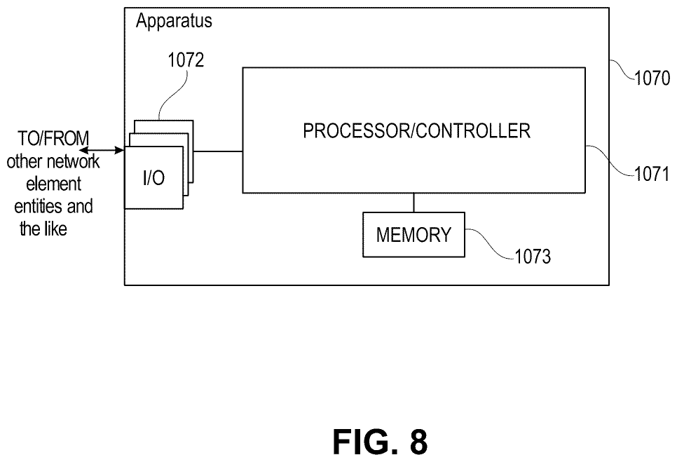

In FIG. 8, a block circuit diagram illustrating a configuration of an apparatus 1070 is shown, which is configured to implement at least part of the present subject matter. It is to be noted that the apparatus 1070 shown in FIG. 8 may comprise several further elements or functions besides those described herein below, which are omitted herein for the sake of simplicity as they are not essential for the understanding. Furthermore, the apparatus may be also another device having a similar function, such as a chipset, a chip, a module etc., which can also be part of an apparatus or attached as a separate element to the apparatus 1070, or the like. The apparatus 1070 may comprise a processing function or processor 1071, such as a central processing unit (CPU) or the like, which executes instructions given by programs or the like related to a flow control mechanism. The processor 1071 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 1072 denotes transceiver or input/output (I/O) units (interfaces) connected to the processor 1071. The I/O units 1072 may be used for communicating with one or more other network elements, entities, terminals or the like. The I/O units 1072 may be a combined unit comprising communication equipment towards several network elements or may comprise a distributed structure with a plurality of different interfaces for different network elements. Reference sign 1073 denotes a memory usable, for example, for storing data and programs to be executed by the processor 1071 and/or as a working storage of the processor 1071.

The processor 1071 is configured to execute processing related to the above described subject matter. In particular, the apparatus 1070 may be configured to perform the method as described in connection with FIG. 2, 4 or 5.

For example, the processor 1071 is configured for: determining a transmission configuration for an energy efficient transmission of a set of RF signals, the transmission configuration indicating a set of transmission paths for transmission of the set of RF signals respectively, each transmission path comprising a respective power amplifier of a set of power amplifiers and a respective antenna of a set of antennas.

As will be appreciated by one skilled in the art, aspects of the present invention may be embodied as an apparatus, method, computer program or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer executable code embodied thereon. A computer program comprises the computer executable code or “program instructions”.

Any combination of one or more computer readable medium(s) may be utilized. The computer readable medium may be a computer readable storage medium. A ‘computer-readable storage medium’ as used herein encompasses any tangible storage medium which may store instructions which are executable by a processor of a computing device. The computer-readable storage medium may be referred to as a computer-readable non-transitory storage medium. The computer-readable storage medium may also be referred to as a tangible computer readable medium. In some embodiments, a computer-readable storage medium may also be able to store data which is able to be accessed by the processor of the computing device.

‘Computer memory’ or ‘memory’ is an example of a computer-readable storage medium. Computer memory is any memory which is directly accessible to a processor. ‘Computer storage’ or ‘storage’ is a further example of a computer-readable storage medium. Computer storage is any non-volatile computer-readable storage medium. In some embodiments computer storage may also be computer memory or vice versa.

A ‘processor’ as used herein encompasses an electronic component which is able to execute a program or machine executable instruction or computer executable code. References to the computing device comprising “a processor” should be interpreted as possibly containing more than one processor or processing core. The processor may for instance be a multi-core processor. A processor may also refer to a collection of processors within a single computer system or distributed amongst multiple computer systems. The term computing device should also be interpreted to possibly refer to a collection or network of computing devices each comprising a processor or processors. The computer executable code may be executed by multiple processors that may be within the same computing device or which may even be distributed across multiple computing devices.

Computer executable code may comprise machine executable instructions or a program which causes a processor to perform an aspect of the present invention. Computer executable code for carrying out operations for aspects of the present invention may be written in any combination of one or more programming languages, including an object oriented programming language such as Java, Smalltalk, C++ or the like and conventional procedural programming languages, such as the “C” programming language or similar programming languages and compiled into machine executable instructions. In some instances the computer executable code may be in the form of a high level language or in a pre-compiled form and be used in conjunction with an interpreter which generates the machine executable instructions on the fly.

Generally, the program instructions can be executed on one processor or on several processors. In the case of multiple processors, they can be distributed over several different entities. Each processor could execute a portion of the instructions intended for that entity. Thus, when referring to a system or process involving multiple entities, the computer program or program instructions are understood to be adapted to be executed by a processor associated or related to the respective entity.

1. An apparatus comprising at least one processor; and at least one memory storing instructions that, when executed by the at least one processor, cause the apparatus to perform:
determining a transmission configuration for an energy efficient transmission of a set of radio frequency (RF) signals using a transmitter, the transmitter comprising a set of power amplifiers for amplification of RF signals and a set of antennas for transmitting the amplified RF signals, the transmission configuration indicating a set of transmission paths for transmission of the set of RF signals respectively, each transmission path comprising a respective power amplifier of the set of power amplifiers and a respective antenna of the set of antennas.

2. The apparatus of claim 1, wherein the apparatus is further caused to perform the determining of the transmission configuration for satisfying a criterion on a remaining available power capacity of the set of power amplifiers upon using the transmission configuration for the transmission of the set of RF signals.

3. The apparatus of claim 2, wherein the criterion requires a maximization of the remaining available power capacity.

4. The apparatus of claim 1, wherein the apparatus is caused to perform the determining of the transmission configuration by at least:
determining different candidate sets of transmission paths for transmission of the set of RF signals;
determining for each candidate set of the different candidate sets of transmission paths the available power capacity of the set of power amplifiers;
the criterion being: selecting a candidate set of the different candidate sets of transmission paths having the available power capacity higher than a lowest available power capacity in the different candidate sets of transmission paths; and
wherein the set of transmission paths of the transmission configuration is the selected candidate set of transmission paths.

5. The apparatus of claim 1, wherein the apparatus is caused to perform the determining of the transmission configuration by at least:
sorting the set of power amplifiers by their power capabilities in accordance with a first sorting order, the first sorting order being ascending or descending, the sorting resulting in a ranking of the set of power amplifiers;
sorting the set of antennas by their pathlosses in accordance with a second sorting order, the second sorting order being reversed with respect to the first sorting order, wherein the pathloss of an antenna indicates a reduction in power of a signal propagating between the antenna and a receiver, the sorting resulting in a ranking of the set of antennas; and
defining each transmission path in accordance with the rankings so that the transmission path comprises the power amplifier and the antenna of the same ranking of the set of power amplifiers and the set of antennas.

6. The apparatus of claim 1, wherein the transmitter comprises a power control system, and wherein for each transmission path, the power control system is configured to set a power amplifier output level for the corresponding power amplifier comprised in the transmission path in accordance with a pathloss associated with the corresponding antenna, wherein the apparatus is further caused to perform the determining of the transmission configuration by at least:
selecting a transmission path of the set transmission paths whose antenna is associated with a specific pathloss; and
reconfiguring the power control system to set the power amplifier output level of each power amplifier in accordance with the specific pathloss.

7. The apparatus of claim 1, wherein the transmitter comprises a power control system, wherein for each transmission path, the power control system is configured to set a power amplifier output level for the corresponding power amplifier comprised in the transmission path in accordance with a pathloss associated with the corresponding antenna, wherein the apparatus is further caused to perform the determining of the transmission configuration by at least:
selecting a transmission path of the set transmission paths whose antenna is associated with a specific pathloss; and
reconfiguring, using an individual controller of the apparatus per transmission path, the power control system to set the power amplifier output level of each power amplifier in accordance with the specific pathloss and a respective delta layer adjustment, wherein the delta layer adjustment represents a difference between the pathloss of the selected transmission path and the pathloss of the transmission path associated with the each power amplifier.

8. The apparatus of claim 6, wherein the specific pathloss is the smallest pathloss of the set of transmission paths.

9. The apparatus of claim 6, wherein the setting of the power amplifier output levels is performed in accordance with a single closed loop power control associated with the selected transmission path.

10. The apparatus of claim 9, wherein the apparatus is further caused to perform:
controlling the transmitter for transmitting the set of RF signals in accordance with the transmission configuration; and
reporting in accordance with the closed loop power control the least individual remaining available power capacity of a power amplifier of the set of power amplifiers.

11. The apparatus of any of claim 1, wherein the set of antennas comprises multiple subsets of antennas and the set of power amplifiers comprises multiple subsets of power amplifiers, wherein each subset of power amplifiers of the multiple subsets of power amplifiers is associated with a corresponding subset of antennas of the multiple subsets of antennas, wherein each subset of antennas of the multiple subsets of antennas is comprised in a different front-end module, wherein each transmission path of the set of transmission paths comprises the power amplifier and the antenna of the corresponding subset of power amplifiers and subset of antennas.

12. The apparatus of claim 1, wherein the transmitter is configured to transmit RF signals in accordance with Frequency division duplexing, FDD, wherein the apparatus is further caused to determine pathlosses associated with the set of antennas using network information.

13. The apparatus of claim 1, wherein the set of RF signals are defined in accordance with a Multiple Input Multiple Output (MIMO) technique.

14. The apparatus of claim 1, wherein the apparatus is a user equipment, and wherein the transmitter comprises the apparatus.

15. The apparatus of claim 1, wherein the apparatus is further caused to perform controlling the transmitter to transmit the set of RF signals in accordance with the transmission configuration.

16. A method for transmission of a set of radio frequency (RF) signals using a transmitter, the transmitter comprising a set of power amplifiers for amplification of RF signals and a set of antennas for transmitting the amplified RF signals, the method comprising:
determining a transmission configuration for an energy efficient transmission of the set of RF signals, the transmission configuration indicating a set of transmission paths for transmission of the set of RF signals respectively, each transmission path comprising a respective power amplifier of the set of power amplifiers and a respective antenna of the set of antennas.

17. The method of claim 16, wherein the determining of the transmission configuration is performed for maximization of available power capacity of the set of power amplifiers.

18. The method of claim 16, further comprising:
transmitting the set of RF signals in accordance with the transmission configuration.

19. A non-transitory computer-readable storage medium comprising instructions stored thereon that, when executed by at least one processor, are configured to cause a computing system to perform the method of claim 16.
